(19) United States
(12) Patent Application Publication
(10) Pub. No.: US 2024/0365812 A1
(43) Pub. Date: Nov. 7, 2024

(54) METHODS FOR PROCESSING PROTEIN CONTAINING COMPOSITION, AND PROCESSED PROTEIN BASED EXTRUDED PRODUCTS

(71) Applicant: ARCHER-DANIELS-MIDLAND COMPANY, Decatur, IL (US)

(72) Inventors: Baljit Ghotra, Champaign, IL (US); Seyhun Gemili, Decatur, IL (US); Ali Halalipour, Decatur, IL (US)

(21) Appl. No.: 18/683,229

(22) PCT Filed: Aug. 12, 2022
(86) PCT No.: PCT/US2022/074918

§ 371 Date: Feb. 12, 2024

Related U.S. Application Data
(60) Provisional application No. 63/232,443, filed on Aug. 12, 2021.

(51) Int. Cl. A23J 3/22; A23J 1/14; A23J 3/14; A23J 3/26

(52) U.S. Cl. CPC A23J 3/227; A23J 1/14; A23J 3/14; A23J 3/26

(57) ABSTRACT

In one aspect, the invention provides a method for processing plant based or grain-based protein containing compositions, such as soy granules, defatted soy flakes, and the like. The method comprises decreasing surface area of the protein containing composition using extruder, expeller and other such known techniques, which induces small pores and increased porosity, to provide a texturized protein. The method then comprises adding an aqueous based solvent to the texturized protein to separate the insoluble protein fraction from the soluble fraction. The solvent comprises suitable salts and is maintained at a pH that ranges from about 4.5 to about 7. The solvent may further comprise enzymes that is used to breakdown some of the components present in the insoluble fraction of the protein containing composition. Subsequently, the method comprises separating the insoluble fraction from the soluble fraction using known techniques such as filtration, centrifugation, and the like, and combinations thereof. The method of the invention is robust and versatile in that it can be used under a variety of different conditions without affecting the final yield and purity of the product. The method eliminates the use of harsh conditions and cost intensive equipment that other methods use. In another aspect, the invention provides a protein containing meat analog made by the methods of the invention as well as a food article comprising the protein containing meat analog.

### TECHNICAL FIELD OF THE INVENTION

The invention relates generally to processing protein containing compositions and more specifically to methods of processing protein containing compositions.

### BACKGROUND

There is an increasing demand from consumers for more sustainable and cleaner production practices in food industry. This demand drives food manufacturers to address the challenge in every step of the food chain.

Three generic processes of making soy protein concentrates/isolates/protein-rich flours are known and widely used. These processing methods use defatted soy flakes or flours as starting material which is then further extracted with one of these solvent systems-aqueous-acidic medium, aqueous-ethanol medium, and aqueous-alkali medium. Defatting is achieved by extracting the fat with a suitable solvent such as hexane, which in itself generally results in a slight protein content increase.

In the aqueous-acid process, the protein is extracted in aqueous medium at pH 4-5, which removes non-protein soluble components in water phase, while protein is kept in its insoluble state at its isoelectric point.

The aqueous-ethanol process involves maintaining a specific alcohol concentration to keep proteins in an insoluble state. The defatted soy flakes or flour are extracted with 60-80% aqueous ethanol. The proteins and polysaccharides are insoluble in alcohol, while sugars and other compounds are dissolved in water.

The aqueous-alkali method uses alkaline condition to slurry defatted soy flakes, which are further centrifuged to separate insoluble fraction (rich in non-protein) while the protein rich soluble fraction is recovered and then dried to make soy protein concentrates or isolates.

These processes tend to be energy and labor intensive leading to process inefficiencies. There is considerable room for improvement in processing proteins in the food industry that is ecologically sensitive and stands up to sustainability norms.

### BRIEF DESCRIPTION OF THE INVENTION

In one aspect, the invention provides a method of removing non-protein compounds from a protein containing composition. The method comprises decreasing a surface area of the protein containing composition to provide a texturized protein comprising an at least partially water insoluble protein. The method then comprises adding an aqueous based solvent to the texturized protein comprising the at least partially water insoluble protein to form an aqueous solution. The method further comprises extracting the at least partially water insoluble protein from the aqueous solution. The method then involves separating the at least partially water insoluble protein from the aqueous solution.

In another aspect, the invention provides a method for processing a texturized protein. The method comprises placing the texturized protein in contact with a solvent such that the solvent extracts solubles from the texturized protein. The method then comprises separating the solvent comprising the solubles from the texturized protein.

In yet another aspect, the invention provides a processed protein-based meat analog made by the method described herein.

In a further aspect, the invention provides a food product comprising the processed protein-based meat analog.

### DRAWINGS

These and other features, aspects, and advantages of the present invention will become better understood when the following detailed description is read with reference to the accompanying drawings in which like characters represent like parts throughout the drawings, wherein:

FIG. 1. Protein purity and yield of Bakers Soy Flour and TVP in 70% ethanol and water

FIG. 2. Protein purity and yield from extractions conducted using TVP at 60 C and boiling temperatures.

FIG. 3. Protein purity and yield from extractions using TVP and sodium sulfate at 0%, 1%, 3%, and 5% concentrations.

FIG. 4. Protein purity and yield from extractions using TVP and calcium sulfate at 0%, 1%, 3%, and 5% concentrations.

FIG. 5. Protein purity and yield from extractions using bakers soy flour and No salt, 1% Sodium Sulfate, and 1% Calcium Sulfate at pH 3.0, 4.5, and 6.0

FIG. 6. Protein purity and yield from extractions using TVP and No Salt, 1% Sodium Sulfate, and 1% Calcium Sulfate at pH 3.0, 4.5, and 6.0.

FIG. 7. Composition of Bakers Soy Flour (Raw Material-Bakers Soy Flour) and soy protein concentrates made using Bakers Soy Flour and TVP after extraction with no salt at pH 4.5.

FIG. 8. Composition of Low-Fat Soy Flour (Raw Material-Low Fat Soy Flour) and soy protein concentrates made using Low Fat Soy Grit, Low Fat Soy Flour and P100 after extraction with no salt at pH 4.5.

FIG. 9. SEM pictures of TVP (35× magnification).

FIG. 10. SEM pictures of P100 (35× magnification).

### DETAILED DESCRIPTION

The definitions provided herein are to facilitate understanding of certain terms used frequently herein and are not meant to limit the scope of the present disclosure.

As used in this specification and the appended claims, the singular forms “a”, “an”, and “the” encompass embodiments having plural referents, unless the content clearly dictates otherwise.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the term “or” is generally employed in its sense including “and/or” unless the content clearly dictates otherwise.

As noted herein, in one aspect the invention provides a method of removing non-protein compounds from a protein containing composition. In one embodiment, the method comprises decreasing a surface area of the protein containing composition, to provide a texturized protein and an at least partially water insoluble protein. The decreasing of surface area is typically achieved through shear processing techniques known in the art. This step is done to make fibrous material and is achieved by the extrusion or expander processing of protein containing compositions. Exemplary texturized proteins made by the decreasing of surface area of the protein containing composition include, for example, but not limited to, defatted soy flakes, soy flours or expeller pressed soybean meals. Other grains/seed-based flours, or protein rich fractions that may be used with the present invention include, but are not limited to, proteins from soy, pea, bean, tapioca, sorghum, potato, lentil, wheat and combinations of any thereof.

The method comprises adding an aqueous based solvent to the texturized protein comprising the at least partially water insoluble protein source to form an aqueous solution. Then, the at least partially water insoluble protein source is extracted from the aqueous solution. Extraction is typically achieved using a solvent that comprises at least one of water, or aqueous alcohol. Aqueous alcohol when used is an aqueous-ethanol wherein the ethanol content is greater than about 30% v/v as an extracting solvent.

The solvent further comprises soluble salts at 1% db or higher, which are added into the aqueous extraction process. A wide range of salts can be used including-sodium sulfate, sodium chloride, or calcium chloride and similar.

During the extraction step, it will also be obvious to one skilled in the art to control pH of the solvent at a certain value. An exemplary level at which the pH is maintained is at the isoelectric point of the texturized protein. Useful ranges in the method of the invention are from about 4.5 to about 7. Towards maintaining the pH at the appropriate levels, other pH adjusting compositions may also be added to the solution. Several approved pH adjusting compounds are known in the art, the use of any of which, either alone or in combinations, is contemplated to be within the scope of the invention. In one embodiment, hydrochloric acid of suitable molarity or normality is used to adjust the pH of the solution.

In another embodiment, A method of removing non-protein compounds from a protein containing composition includes adding an aqueous based solvent to the protein containing composition and separating the aqueous based solvent from the protein containing composition. The aqueous based solvent removes at least some of the non-protein compounds from the protein containing composition. The method may further include reducing a surface area of the protein containing composition after the aqueous based solvent has been removed. The reducing of the surface may include extrusion. The protein containing composition may be in a particulate form.

In the various embodiments of the present invention, the protein containing composition may be of a plant-based origin selected from the group consisting of soy, pea, bean, tapioca, sorghum, potato, lentil, wheat, and combinations of any thereof.

One skilled in the art will also be aware that the extracting is conducted at a suitable temperature ranging from ambient conditions to boiling point of the solvent, or even higher at superheated conditions. The choice of temperature depends on various factors involved during the extraction process, may include such as, but not limited to, boiling point of solvent, nature of the raw material used for protein extraction, stability and temperature sensitivity of the raw material, other components present in the extraction solution, and so on.

In some embodiments, the extraction is further conducted in the presence of at least one enzyme. At least one enzyme comprises alpha-glucosidases, non-starch polysaccharide enzymes, or combinations thereof. The at least one enzyme may be used to tailor the final product composition in terms of sugars, non-digestible sugars, and non-digestible fiber components.

The method further comprises separating the at least partially water insoluble protein source from the aqueous solution. This may be achieved in a facile manner using common methods known in the art, and may include, for example, filtration, sedimentation, centrifugation, and the like. In a specific embodiment, the at least partially water insoluble protein source is separated from the aqueous solution using centrifugation technique.

Using the method of the invention, protein-rich products having superior nutrition, taste, and organoleptic acceptability are produced. For example, the method of the invention is used to produce protein-rich soybean proteins. The soybean proteins predominantly comprise globulins that are inherently insoluble in water, which can be removed from the raw material to provide the protein containing composition. The new method leverages the native physical state of proteins and uses an expander or extrusion processing technique to form an insoluble fibrous protein material. This formation of insoluble fibrous material is a critical starting material used in this new method. The textured protein material formed is typically in a semi-moist state (>15% moisture) as it is processed by an extrusion/expander. Optionally, the textured product can be dried (<10% moisture) and stored until use for further extraction. The fibrous material is then extracted using an aqueous solvent at a pH 4 or higher and temperature between 25-95° C. A superheated water (water at >100° C.) can be optionally applied in the extraction process. A pH adjustment to acidic conditions is not required during aqueous extraction as is typically done for white flakes that are acid leached as disclosed in a prior art.

Thus, in another aspect, the invention provides a method for processing a protein containing composition. Exemplary protein containing compositions include, for example, but not limited to, defatted soy flakes, soy flours or expeller pressed soybean meals. Other grains/seed-based flours, or protein rich fractions are included as extended botanical origins that can also be processed using the new method. The method comprises providing a texturized protein that is made by decreasing surface area of the protein containing composition. This is achieved by the extrusion or expander processing of the plant-based or grain-based protein containing compositions.

The method then comprises placing the texturized protein in contact with a solvent such that the solvent extracts solubles from the texturized protein. The solvent useful in the invention is an aqueous based solvent that comprises at least one of water, or aqueous alcohol. Aqueous alcohol when used is aqueous-ethanol wherein the ethanol content is greater than about 30% v/v as an extracting solvent.

The solvent further comprises soluble salts at 1% db or higher, which are added into the aqueous extraction process. A wide range of salts can be used including-sodium sulfate, sodium chloride, or calcium chloride and similar.

The pH of the solvent may be controlled at a certain value. An exemplary level at which the pH is maintained is at the isoelectric point of the texturized protein. This may range from about 4.5 to about 7. Towards maintaining the pH at the appropriate levels, other pH adjusting compositions may also be added to the solution. Several pH adjusting compounds that are approved as food processing additives are known in the art, the use of any of which, either alone or in combinations, is contemplated to be within the scope of the invention. In one embodiment, hydrochloric acid of suitable molarity or normality is used to adjust the pH of the solution.

One skilled in the art will also be aware that the contacting the texturized protein with the solvent may be conducted at a suitable temperature ranging from ambient conditions to boiling point of the solvent. The choice of temperature depends on various factors involved during the extraction process, may include such as, but not limited to, boiling point of solvent, nature of the raw material used for protein extraction, stability and temperature sensitivity of the raw material, other components present in the extraction solution, and so on.

In some embodiments, the contacting is further conducted in the presence of at least one enzyme. At least one enzyme comprises alpha-glucosidases, non-starch polysaccharide enzymes, or combinations thereof. The at least one enzyme may be used to tailor the final product composition in terms of sugars, non-digestible sugars, and non-digestible fiber components.

The method for processing a protein containing composition further comprises separating the solvent comprising the solubles from the texturized protein. This may be achieved in a facile manner using common methods known in the art, and may include, for example, filtration, sedimentation, centrifugation, and the like. In a specific embodiment, the at least partially water insoluble protein source is separated from the aqueous solution using centrifugation.

Using the methods of the invention, processed protein-based compositions are obtained having specific compositions, tailored properties such as taste, organoleptic acceptability and the like. The raw material for the processed protein-based composition is plant based or grain based raw material and may be tailored to appear and taste like a meat-based product. Thus, in yet another aspect, the invention provides a processed protein-based meat analog made by the methods of the invention. In one specific embodiment, the processed protein-based meat analog has a protein content of more than 65% db, sugars and non-digestible sugars are less than 7% db, and dietary fiber content is less than 28% db. In another specific embodiment, processed protein-based meat analog has a protein content of 55% to 65% db, sugars and non-digestible sugars less than 7% db, and dietary fiber component more than 28% db.

The processed protein-based meat analog may further be processed to improve its texture or impart certain other properties to it. For example, the meat analog made by the methods described herein may then be functionalized through known techniques to improve its solubility. Alternately, its rheological or stabilizing properties may be modified to enable its further processing according to its end use application. Other such processing techniques would be known to one skilled in the art and is contemplated to be within the scope of the invention. Some exemplary meat analogs that can be made using the methods of the invention include vegan meat, chicken, seafood, or dairy analogues.

The meat analogs can be used as ingredients in food and beverage categories, such as a sandwich or a wrap. Thus, in a further aspect, the invention provides a food product comprising the processed protein-based meat analog made by the methods described herein.

### Examples

The following raw materials were used for the extraction experiments described herein.

TABLE 1
Raw materials used to make protein
concentrates and their compositions

| | Manufacturer | Protein, | Sugar, | Ash, | Other, |
|---|---|---|---|---|---|
| Raw material | Location | % | % | % | % |
| Bakers Soy Flour | Decatur, IL | 55.28 | 7.16 | 8.30 | 29.26 |
| TVP | Decatur, IL | 55.31 | 7.37 | 13.92 | 23.40 |
| Low Fat Soy | Indianola, IA | 51.53 | 15.11 | 7.69 | 25.67 |
| Flour | | | | | |
| Low Fat Soy Grit | Indianola, IA | 51.98 | 12.03 | 7.15 | 28.84 |
| P100 | Indianola, IA | 55.01 | 14.02 | 6.71 | 24.26 |

### Methods and Materials

Extractions were conducted using pure water or saline solutions with pH adjustment. Sodium sulfate and calcium sulfate were evaluated in separate experiments to determine which, if either, contributed to reduction of protein losses. Salt concentrations that were tested and their associated weight of salt and solvent are shown in Table 2.

TABLE 2
Salt & solvent amounts and concentrations
used as extraction solutions

| | | Weight of Solvent (Water or 70% |
|---|---|---|
| Salt Concentration | Weight of Salt | Ethanol) |
| 0% | 0.0 g | 950.0 g |
| 1% | 10.0 g | 940.0 g |
| 3% | 30.0 g | 920.0 g |
| 5% | 50.0 g | 900.0 g |

### Extraction Procedure

Solvent is weighed into a 2000 mL beaker based on the weights given in Table 2. Then stir bar is added to the beaker and temperature probe is inserted in the liquid, after which heating is set to 60° C. and stirring is set to 250 rpm. Then, appropriate amounts of sodium or calcium salt is added based on the weights given in table 2. Once the temperature inside the beaker reaches 60° C., 50.0 g protein sample is added to the beaker and stirring is increased to 400 rpm. After 5 minutes from sample addition, initial pH is measured, then 1M HCl is used to adjust the pH to either 3.0, 4.5, or 6.0. The pH range is monitored for 5 minutes, making adjustments with HCl as necessary to maintain desired pH. The pH and volume of acid needed for adjustment 10 minutes after sample addition is recorded. After sample is mixed for 30 minutes, stirring is discontinued and removed from heating. A filter cloth is placed in a basket centrifuge and the protein slurry is emptied into the basket. The basket centrifuge speed is ramped up to 3000 rpm. As filtrate outflow tapers off, 950 mL DI water is slowly added to the basket while it runs to wash the sample. The wash is repeated two more times. After final wash volume is added, the centrifuge is allowed to run until filtrate stops flowing from the centrifuge outlet. The basket centrifuge is then turned off and the filter cloth is removed. The solids collected in the filter cloth are then collected onto a metal tray. The tray is placed in a forced-air oven at 40° C. for 24 hours to dry. The dried samples are weighed, collected, and ground with a spice grinder. The protein powders are analyzed for percent moisture, protein, sugar, fiber, ash, & fat.

### Results

### Extraction Media Selection

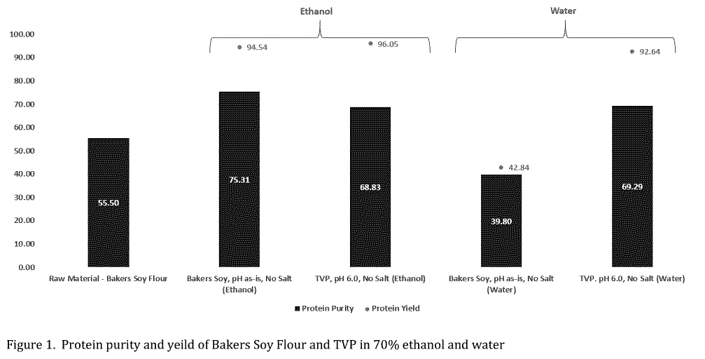

Initial experiments determined the protein purity and yield differences when extracting Bakers Soy Flour and TVP with water in place of ethanol at bench scale (see FIG. 1). This extraction without pH adjustment is comparable to what ADM uses for commercial production of SPC. FIG. 1 shows that replacing ethanol with water as an extraction media decreased purity for bakers flour (from 75.31% to 39.80%); however no significant impact was seen when TVP used (68.83% for ethanol and 69.29% for water). Similar trend was observed for yield of the production. Replacing ethanol with water decreased yield for bakers flour (from 94.54% to 42.84%); however the impact on yield is minimal when TVP is used (96.05% for ethanol and 92.64% for water). Further experiments in this project were conducted using water as the extraction media to understand the effect of pH and salt on purity and yield of protein extraction from flours, grits and textured products as well as the impact on final product composition. Ingredients were selected from two manufacturing locations. One set of ingredients (Bakers flour and TVP) was from Decatur plant and one set of ingredients (Low-fat soy flour, Low-fat soy grit, and P100 (textured product)) was from Indianola. The differences between the two sets are Decatur samples were made using GM soybeans as raw material and defatted using hexane extraction; whereas Indianola samples were made using Non-GM soy beans and defatted using expeller press extraction.

### Temperature Selection

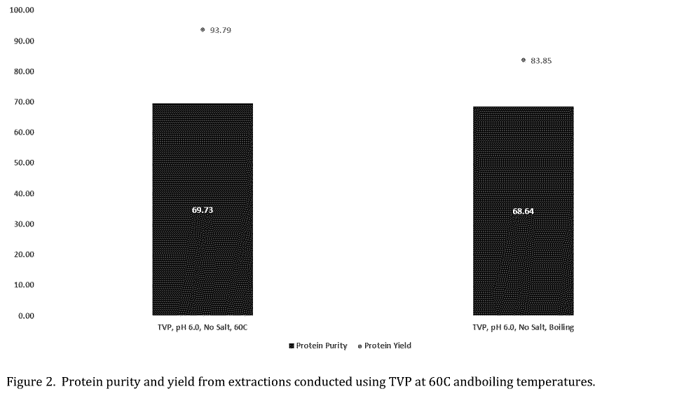

Using water as the extraction media, effect of temperature was evaluated at 60° C. and at boiling temperature (95° C.-100° C.). 60° C. is the minimum temperature used in commercial production of protein ingredients to avoid microbial growth. Boiling temperature was additionally investigated as the maximum temperature in normal conditions. FIG. 2 shows the impact of temperature on yield and purity using TVP. The most significant impact of temperature was on the yield of production: 93.79% yields at 60° C. and 83.85% yields at boiling temperature were obtained. There was no significant impact on purity. Ongoing experiments were conducted only at a temperature of 60° C. in DI water to reduce the apparent losses caused by increasing heat during the reaction.

### Salt and Salt Concentration Selection

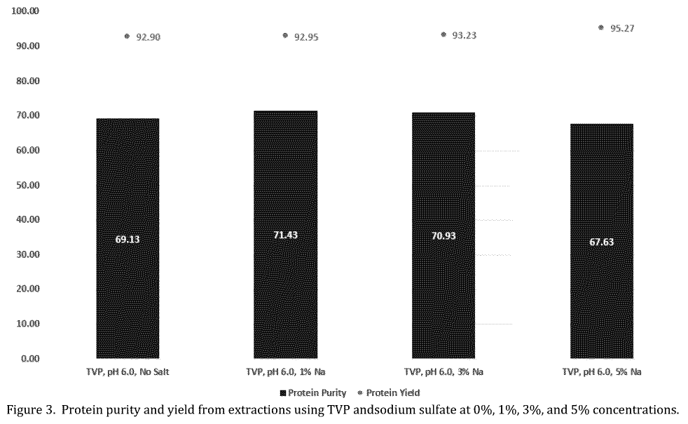

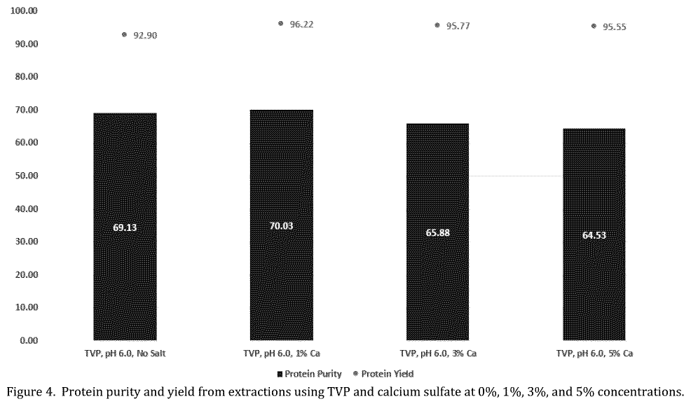

Sodium sulfate and calcium sulfate were both evaluated at concentrations of 1%, 3%, and 5%, relative to the weight of TVP used (see table 2 for weights). FIG. 3 shows the impact of sodium sulfate on protein yield and purity using TVP. These experiments were conducted in DI water at 60° C., based on previous experimental findings. Protein yield increased (92.9% to 95.3% yield) as concentration of sodium sulfate increased from 0% to 5%. Protein purity was highest at 1% sodium sulfate (71.43%), then decreased slightly as salt concentration increased (67.63% protein at 5% sodium sulfate). FIG. 4 shows the impact of calcium sulfate on protein yield and purity using TVP. Calcium sulfate had the most impact on protein purity. The salt-free solution showed 69.13% protein, which then increased to 70.03% protein at 1% calcium sulfate. Further increases in salt concentration reduced protein purity, 65.88% protein at 3% calcium sulfate, and 64.53% protein at 5% calcium sulfate. Protein yield increased from 92.90% in salt-free solution to 96.22% in 1% calcium sulfate, but no further yield improvements were observed with salt levels above 1%. With no significant changes in protein yield and purities occurring with salt concentrations above 1%; this concentration of sodium sulfate and calcium sulfate was used for all further extractions.

### Selection of Extraction Conditions

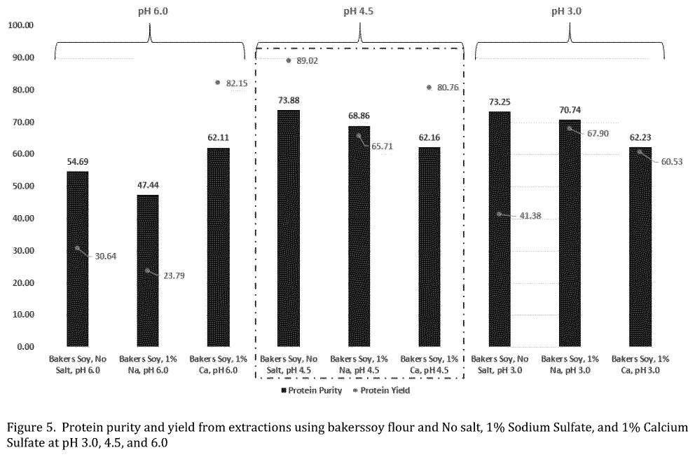

Previous experimental results on the impacts of extraction media, temperature, salts, and salt concentrations on protein purification and yield defined the next set of experiments to compare selected textured products and their respective raw materials. Water based solutions at 60° C. were used for all samples. 1% sodium sulfate, 1% calcium sulfate, and no salt at pH levels of 3.0, 4.5, and 6.0 were evaluated. Raw materials included TVP, Bakers Soy Flour, Low-fat Soy Grit, Low-fat Soy Flour, and P100. FIG. 5 shows the impact of pH and use of calcium and sodium salts on purity and yield using bakers soy flour. Yields and purities reached the highest levels of 89.02% and 73.88%, respectively at pH 4.5 in a salt-free solution. Extractions conducted at pH3.0 in salt-free solution had a yield of 41.38% compared to 89.02% at pH 4.5. However, there was no significant impact on the protein purity. Increasing pH from 4.5 to 6.0 decreased the yield from 89.02% to 30.64% and the purity from 73.88% to 54.69%. Protein purity of the finished products was around 62% when 1% calcium sulfate solutions were used at all pH levels. However, purity increased in the case of using sodium sulfate and no salt when pH decreased from 6 to 4.5 and 3.0. Overall, the highest purity results were obtained when no salt was used.

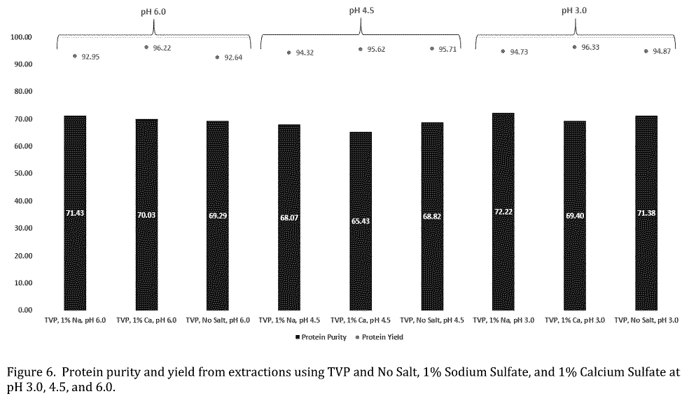

FIG. 6 shows the purity and yield results obtained using TVPs at various pH levels and using calcium and sodium salts and no salt. Overall, there was no significant impact of pH and use of calcium or sodium salts on the purity and yield of production. Protein concentration was always above 65% and yield of production was always above 92%. This is a novel finding as this process gives greater flexibility in operations to always obtain minimum required protein levels with high yields consistently even when there is significant changes in extraction conditions.

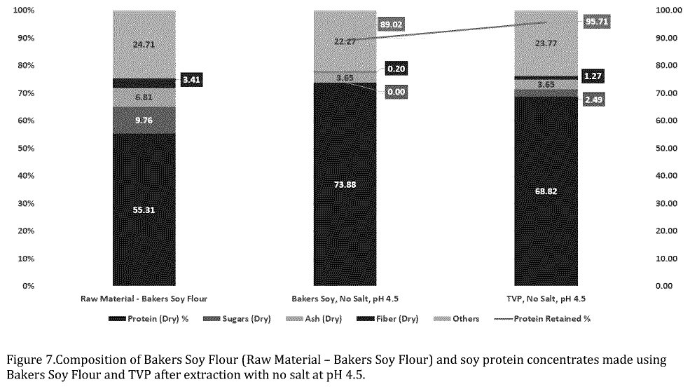

Soy protein concentrates made using bakers soy flour and TVP were compositionally compared to each other and also to bakers soy flour in FIG. 7. While ash content in the finished products were similar to each other, soy protein concentrate made using TVP had higher levels of fiber and sugar compared to the soy protein concentrate made using bakers soy flour.

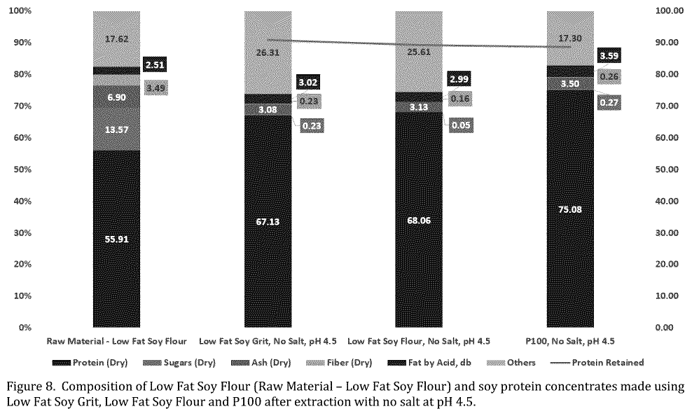

Further extractions were conducted using low fat soy grits, low fat soy flour and P100 at pH 4.5 and with no salt, and results are reported in FIG. 8. Using low-fat soy flour and low-fat soy grits, similar protein purity and yield at pH 4.5 with no salt is obtained, and also the extracted product showed very similar compositional profile. Using P100 in the same conditions (pH 4.5 and no salt) reduced the “Others” fraction of the composition and created significantly higher content of protein in the final protein concentrate (75.08% versus 67.13% and 68.06%) while no change in yield of production (˜90%). The increase in protein content using P100 is novel, unexpected and unique to this product, which is not observed when using bakers flour and TVP (See FIG. 7).

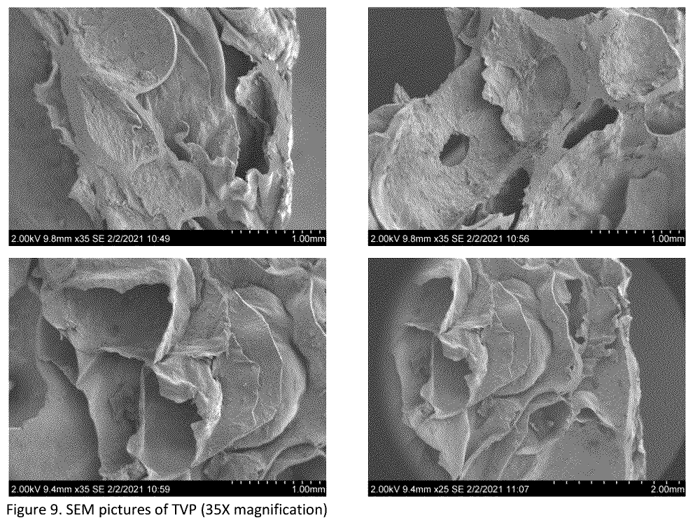

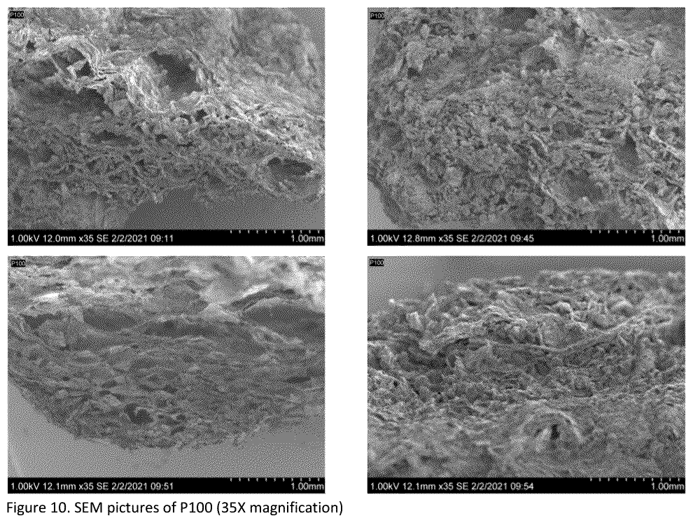

FIGS. 9 and 10 show the scanning electron microscope (SEM) pictures of TVP and P100, respectively. As seen in the SEM pictures, P100 has smaller pores but higher porosity compared to TVP. Without being bound to any theory, it is hypothesized that the combination of smaller pores and increased porosity in P100 created more surface area, and hence the soluble fibers are conducive for removal more effectively compared to TVP. The increase in removal of more impurities using P100 yielded higher protein purity in the end product with no significant impact on the yield of production.

Thus, the method of the invention provides for flexible operation conditions to produce protein concentrates from protein containing compositions by texturizing raw materials prior to subjecting it to the extraction conditions. Further, decrease in pore size and increase in porosity (overall structure of the textured proteins) increases the impurity removal efficiency, and hence providing products with increased protein levels with no negative impact on the yield of production.

The methods described herein presents a breakthrough in producing protein rich products from plant-based or grain-based raw materials. This technique uses a simple, science-based approach to remove non-protein, water soluble components in an aqueous medium while the protein-rich fraction is extracted in its insoluble or fibrous state. This protein rich fraction is then recovered as a solid fraction by simple solid-liquid separation, as is commonly applied in the food or feed ingredient manufacturing industry.

The methods provide a cost effective and sustainable manufacturing method that uses low capital manufacturing unit operations. Additionally, it enables the elimination of harsh solvents and high levels of alkali or acid conditions in the manufacturing process of making protein rich products. The aqueous extraction method under saline conditions provides an alternative method to retain higher amount of dietary fibers in the final product while still effectively eliminating sugars and non-digestible carbohydrates. This allows for nutritionally superior soy protein flour products that contain higher dietary fiber compared to products made by a simple aqueous extraction without the use of salts. Table 3 Summarizes the mass balance of extractions performed on Prototype #1 and Prototype #2.

| | | | | | | Sugars and | | Other components | Other components |
|---|---|---|---|---|---|---|---|---|---|
| | | | | | Weight of | non- | Sugars and | mainly insoluble | mainly insoluble |
| | | | | | net | digestible | non- | fiber (lipids + ash + | fiber (lipids + ash + |
| | Weight, g | Moisture, | Weight, | Protein | protein | sugars (%, | digestible | trace components), | trace components), |
| | (as is) | %, db | db (g) | (%, db) | (g) | db) | sugars (g) | % db | (g) |
| Before wash | 25.08 | 4.90% | 23.9 | 56.1% | 13.4 | 16.1% | 3.8 | 27.7% | 6.6 |
| Protoytpe#1 | 18.18 | 6.8% | 17.0 | 66.6% | 11.3 | 6.6% | 1.1 | 26.8% | 4.5 |
| (after water | | | | | | | | | |
| wash) | | | | | | | | | |
| Before Wash | 25.21 | 4.90% | 24.0 | 56.1% | 13.5 | 16.1% | 3.9 | 27.7% | 6.7 |
| Prototype#2 | 23.1 | 6.5% | 21.6 | 56.7% | 12.3 | 6.6% | 1.4 | 36.6% | 7.9 |
| (after 5% salt | | | | | | | | | |
| water) | | | | | | | | | |

The improved method provides the advantage of cost savings by eliminating the need of capital intensive unit operations, such as ethanol handling, de-solventizer and evaporators, spray dryer, etc., which are typically required in conventional aqueous ethanol or aqueous-alkali process. The new process allows a simpler processing design, making the processing more sustainable compared to current commercial methods. The process eliminates high level of alkali, acid, or ethanol use which protects proteins from partial denaturation that is known to happen to proteins when exposed to such conditions. Alkali/acid extraction step results in excessive salt formation, which also in turn leads to ash formation in the final product. Removal of ash requires capital-intensive membrane technology. This is eliminated in the novel methods described herein.

The product made by using the expeller pressed soybean meal as a starting material is preferred as a raw material to make a solvent-free soybean protein concentrate. This improves overall acceptability of products compared to current soy protein products that are typically made using defatted soy flakes (which are hexane-extracted and desolventized), followed by ethanol wash process.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of removing non-protein compounds from a protein containing composition, comprising:
decreasing a surface area of the protein containing composition to provide a texturized protein comprising an at least partially water insoluble protein source;
adding an aqueous based solvent to the texturized protein comprising the at least partially water insoluble protein source to form an aqueous solution;
separating the at least partially water insoluble protein source from the aqueous solution; and
separating the at least partially water insoluble protein source from the aqueous solution.

2. The method of claim 1, wherein the protein containing composition is at least one of plant based, or grain based.

3. The method of claim 1, wherein the decreasing the surface area comprises subjecting the protein containing composition through at least one of an expeller, an extruder, or both.

4. The method of claim 1, wherein the extracting uses a solvent comprising at least one of water, or aqueous alcohol.

5. (canceled)

6. The method of claim 4, wherein the pH of the solvent is maintained at the isoelectric point of the texturized protein.

7-8. (canceled)

9. The method of claim 4, wherein the solvent further comprises at least one enzyme.

10. (canceled)

11. A method for processing a texturized protein, wherein the method comprises:
placing the texturized protein in contact with a solvent such that the solvent extracts solubles from the texturized protein; and
separating the solvent comprising the solubles from the texturized protein.

12. The method of claim 11, wherein the texturized protein is derived from at least one of plant based, or grain based raw material.

13. The method of claim 12, wherein the texturized protein is made by pressurizing the raw material through at least one of an expeller, an extruder, or both.

14. The method of claim 11, wherein the solvent is water, or aqueous alcohol.

15. The method of claim 11, wherein the solvent further comprises a salt selected from the group comprising sodium sulfate, sodium chloride, calcium chloride, calcium sulfate or combinations thereof.

16. The method of claim 11, wherein the pH of the solvent is maintained at the isoelectric point of the texturized protein.

17-18. (canceled)

19. The method of claim 11, wherein the solvent further comprises at least one enzyme.

20-21. (canceled)

22. A processed protein-based meat analog made by the process of claim 11.

23. (canceled)

24. A method of removing non-protein compounds from a protein containing composition, the method comprising:
adding an aqueous based solvent to the protein containing composition;
separating the aqueous based solvent from the protein containing composition, wherein the aqueous based solvent removes at least some of the non-protein compounds from the protein containing composition.

25. The method of claim 24, further comprising reducing a surface area of the protein containing composition after the aqueous based solvent has been removed.

26. The method of claim 25, wherein reducing the surface area of the protein containing composition comprises extruding the protein containing composition.

27. The method of claim 24, wherein the protein containing composition is in a particulate form.

28. The method claim 24, wherein the protein containing composition is of a plant-based origin.

29. The method of claim 28, wherein the protein containing composition is of an origin selected from the group consisting of soy, pea, bean, tapioca, sorghum, potato, lentil, wheat, and combinations of any thereof.
